(19) United States
(12) Patent Application Publication
(10) Pub. No.: US 2010/0195818 A1
(43) Pub. Date: Aug. 5, 2010

(54) TERMINATION FOR TELECOMMUNICATION AND DATA ENGINEERING

(75) Inventors: Adrian Benedetto, Berlin (DE); Harald Klein, Berlin (DE)

Correspondence Address: MERCHANT & GOULD PC, P.O. BOX 2903, MINNEAPOLIS, MN, 55402-0903, US

(73) Assignee: ADC GmbH, Berlin (DE)

(21) Appl. No.: 12/668,362

(22) PCT Filed: Jun. 24, 2008
(86) PCT No.: PCT/EP2008/005071

§ 371 Date: Jan. 8, 2010

(30) Foreign Application Priority Data
Jul. 9, 2007 (DE) 10 2007 032 579.9

(51) Int. Cl. H04M 1/00

(52) U.S. Cl. 379/419

(57) ABSTRACT

The invention relates to a termination (1) for telecommunication and data engineering, comprising a housing (10) which contains terminal strips for connecting up a prescribed number of pairs, wherein the housing (10) is designed to have mounting means which can be used to mount the housing (10) on supports (60), wherein the terminal strips are in the form of printed circuit board connectors (50), wherein the housing (10) contains a plurality of printed circuit boards (70) which are accessible from the front and the rear of the housing (10), wherein the printed circuit board connectors (50) are plugged onto the printed circuit boards (70) from the front of the housing (10) and are plugged onto the printed circuit boards (70) from the rear of the housing (10), wherein the printed circuit boards (70) hold conductor tracks which are respectively used to connect a contact on a printed circuit board connector (50) from the front to a contact on a printed circuit board connector (50) from the back.

The invention relates to a terminal head for telecommunication and data engineering.

In existing copper telecommunication networks, the access network is constructed as radial network in most cases. In this network configuration, the main cables are brought out of the switching office and distributed to the various cable distributors of the corresponding subscriber regions. The main cable is distributed to the various cable distributors via cable sleeves. From the cable sleeves, the distributed main cables then go to the cable distributors where they are connected to terminal heads and are run as distribution cables in the respective streets of the subscribers. The connection to the terminal distribution box of the subscriber is then made in most cases by means of a sleeve in the distribution cable. Due to this fanning out of the network towards the subscriber, the connection of the main cables at the subscriber or line side at the main distributor is the only location in the access network where all connections (lines) run together in space and can be centrally tested. The number of terminal heads in a cable distributor is dependent on the type of construction of the cable distributor, but a typical value is about 12 terminal heads per cable distributor.

A terminal head consists, for example, of a mounting or receiving shell for 10 terminal strips which, in turn can in each case connect 10 pairs. Thus, 100 pairs can be connected by means of one terminal head. The receiving shell is then preferably hooked into the cable distributor rack with preassembled clamping nuts, and the clamping nuts then snap in behind the rack rails. The receiving shell is then clamped by tightening fitting screws and a ground connection is made.

The rack rails can be dimensioned in length in such a manner that a number of terminal heads can snap in (for example three), or can be designed for only one terminal head.

From DE 10 2004 017 605 A1, a connector for circuit boards is known comprising a number of contact elements, the contact elements in each case having two connecting sides, one connecting side being constructed as insulation displacement contact for connecting wires and the other connecting side being constructed as forked contact for contacting terminal areas on the circuit board.

The invention is based on the technical problem of creating a terminal head which has a higher terminal density.

The solution of the technical problem is obtained through the subject matter having the features of claim 1. Further advantageous embodiments of the invention are obtained from the subclaims.

For this purpose, the terminal head for telecommunication and data engineering comprises a housing in which terminal strips are arranged for interconnecting a predetermined number of pairs, the housing being constructed with attachment means by means of which the housing can be attached to carriers, the terminal strips being constructed as circuit board connectors, characterized in that in the housing, a number of circuit boards are arranged which are accessible from the front and the rear of the housing, characterized in that the circuit board connectors are plugged onto the circuit board from the front of the housing and are plugged onto the circuit boards from the rear of the housing, characterized in that conductor runs are arranged on the circuit boards via which in each case one contact of a circuit board connector of the front is connected to a contact of a circuit board connector of the rear via the in each case common circuit board. This makes it possible to considerably increase the terminal density since the distributed main cable is connected at the rear of the housing, whereas the entire front is available for connecting the jumper wires, characterized in that the number of terminals can be doubled per row, that is to say 20 pairs, for example, can now be connected per row instead of previously 10 pairs. This makes it possible to halve the constructional height, an increase in width being uncritical as long as the terminal head fits between the existing carriers since a terminal head with 100 pairs now only needs five rows instead of previously ten rows. The carriers are preferably of metal. The circuit board connector preferably comprises a number of contact elements, the contact elements in each case having two terminal sides, characterized in that one terminal side is constructed as insulation displacement contact for connecting wires and the other terminal side is constructed as forked contact for contacting terminal areas on the circuit board, reference being made expressly to DE 10 2004 017 605 A1 with respect to the actual construction.

In a preferred embodiment, the housing has a detachable rear wall. Before the rear wall is mounted, the circuit boards can then be pushed into the housing where they are guided and supported. After the rear wall has been attached, they are then arranged captively in the housing. By detaching the rear wall, defective circuit boards can then be exchanged or the terminal head can be equipped with other circuit boards which, for example, have overvoltage protection elements or filter circuits such as splitters.

In a further preferred embodiment, a lug for attaching a cable is arranged at the rear wall which also preferably has a leg which is arranged centrally over the entire height at the rear wall and is used for attaching wire groups.

In a further preferred embodiment, the housing is constructed to be stepped, the housing being wider at the rear than at the front.

In a further preferred embodiment, the housing is of metal or metalized. Apart from great stability, a metal housing has good EMC and can also be used for a ground connection. In principle, the housing can also consist of plastic, however.

In a further preferred embodiment, onto each circuit board, two circuit board connectors are plugged from the front and two circuit board connectors are plugged from the rear, the distance between the circuit board connectors of the rear being greater. In this arrangement, there is preferably an unambiguous correlation between a circuit board connector of the front to a circuit board connector of the rear so that the conductor runs on the circuit board are run without cross-overs from the front to the rear of the circuit board or a deliberate antiphase crosstalk is created by crossing conductor runs in order to reduce the crosstalk between the adjacent pairs or capacitive asymmetries caused by the circuit board connectors due to capacitive couplings between the layers of a multi-layer board are compensated for. With regard to the individual circuit board connectors, it must be noted that constructional forms are conceivable where only a single circuit board connector for, for example, 20 pairs is arranged at the front whereas two circuit board connectors with 10 pairs each are arranged at the rear. Other embodiments are also conceivable. Furthermore, a constructional form is also to be protected expressly where each row has exactly one circuit board connector at the front and one circuit board connector at the rear.

In a further preferred embodiment, guides for the jumper wires are arranged in each case at the front conductor walls or the front part pieces of the side parts.

In a further preferred embodiment, the circuit board connectors of the rear and/or of the front are constructed with interfaces for an arrester magazine. The interface can be constructed, for example, as break contact or as forked contact. The arrester magazines are preferably inserted from the rear so that the patching is not impeded.

In a further preferred embodiment, on the top part and/or the bottom part of the housing, pivotable levers are arranged by means of which the terminal head can be attached to carriers. As result, the clamping nuts can be omitted so that the full width of the housing is available for the circuit board connectors.

In a further preferred embodiment, two pivotable levers are arranged in each case on the top part and the bottom part of the housing which results in greater and more uniform attachment.

In a further preferred embodiment, the levers have an excentric bend at which a hook-shaped element is arranged.

In a further preferred embodiment, the housing is constructed with stopping means for the levers.

In the text which follows, the invention will be explained in greater detail with reference to a preferred exemplary embodiment. The figures show in:

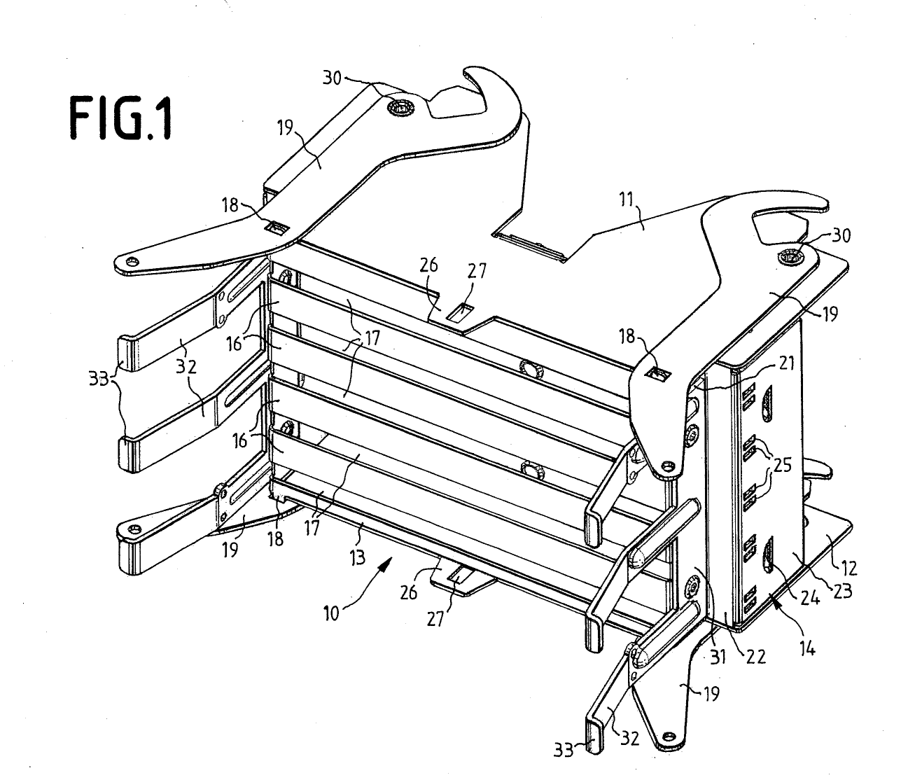

FIG. 1 a perspective front view of an unequipped housing of a terminal head,

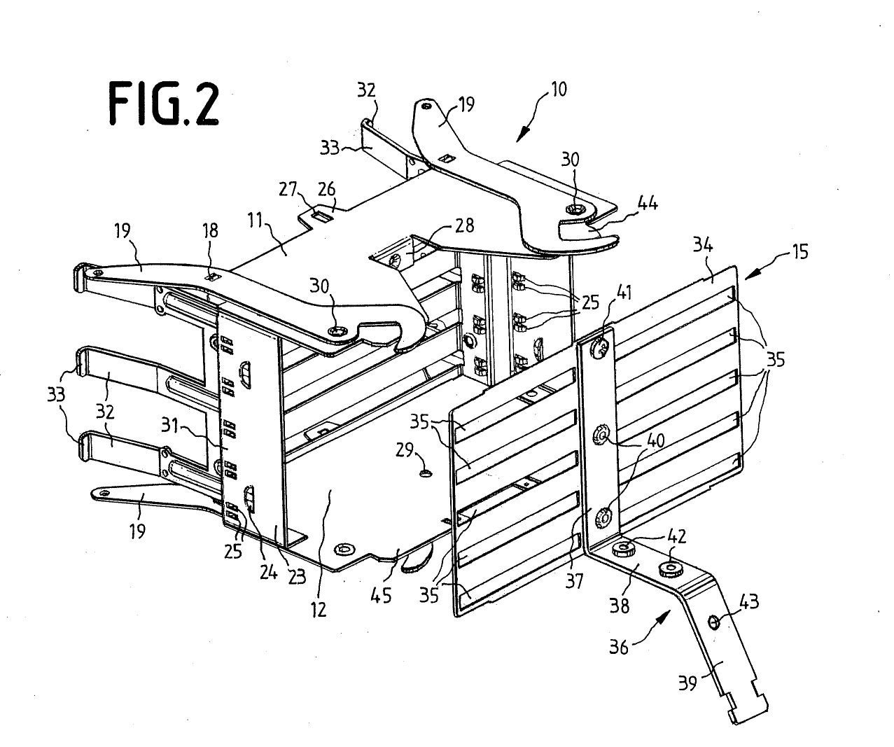

FIG. 2 shows a perspective rear view of an unequipped housing with the rear wall removed,

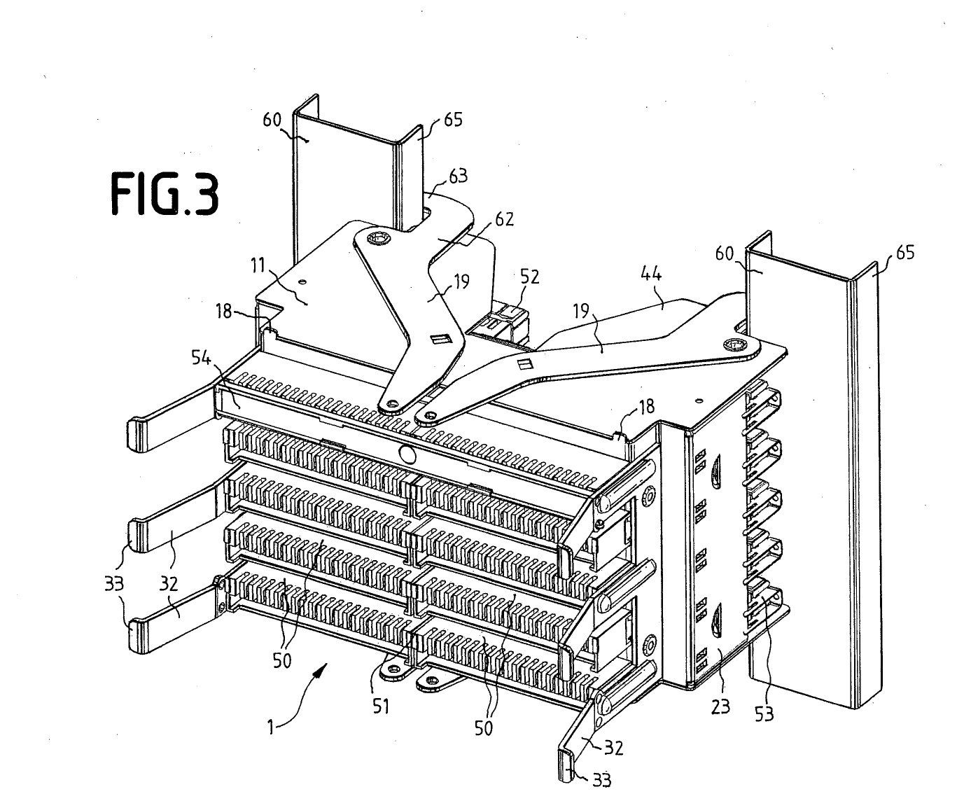

FIG. 3 shows a perspective front view of a fully equipped housing,

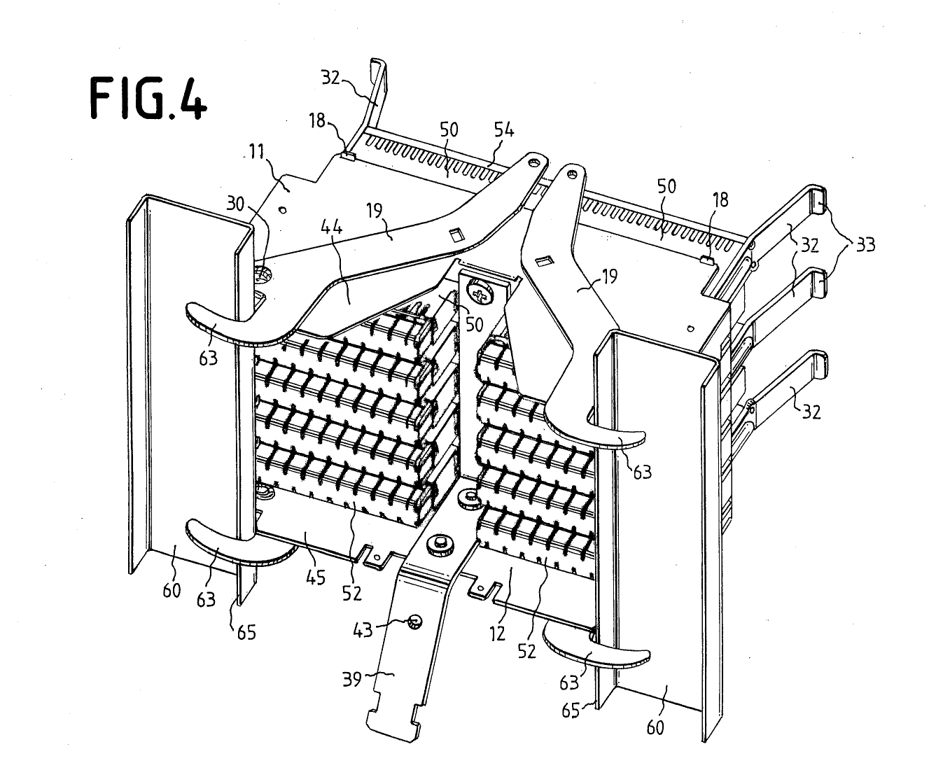

FIG. 4 shows a perspective rear view of the fully equipped housing,

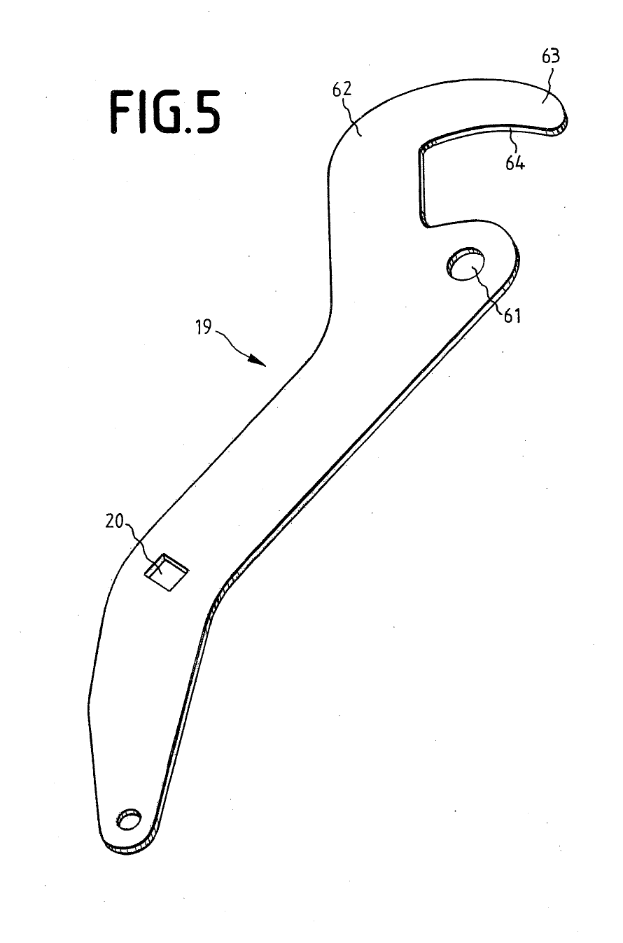

FIG. 5 shows a top view of a lever, and

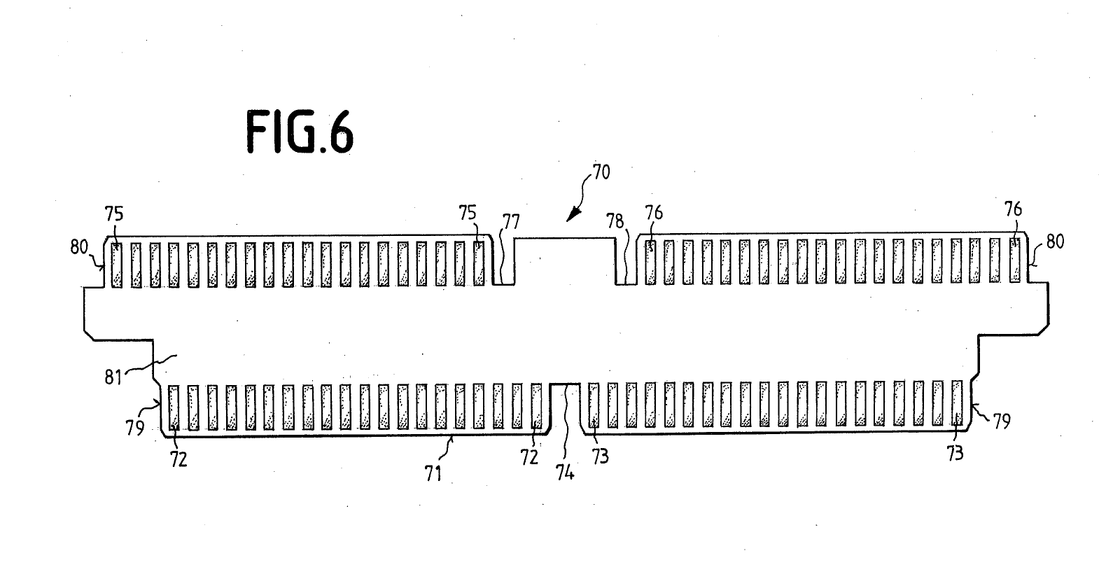

FIG. 6 shows a diagrammatic top view of a circuit board.

FIG. 1 shows a housing 10 of a terminal head 1 (see FIG. 3). The housing 10 comprises a top part 11, a bottom part 12, a front part 13, two side parts 14 and a rear wall 15 (see FIG. 2). The top part 11, the bottom part 12, the front part 13 and the two side parts 14 are preferably permanently connected to one another, for example riveted. The front part 13 has six horizontal metal rails 16 between which five slots 17 are formed for inserting circuit board connectors. The lowermost metal rail 16 is slightly narrower than a top metal rail 16. From the topmost metal rail 16 and from the lowermost metal rail 16, two lugs 18 protrude in each case which are used as stopping means for levers 19, arranged at the top part 11 and at the bottom part 12, respectively, which engage openings 20 of the levers 19 (see FIG. 5). The side parts 14 are constructed to be stepped in width. A first part piece 21 adjoins the front part 13, from which part piece a second part piece 22, angled towards the outside at right angles, protrudes from which a third part piece 23 protrudes which protrudes at right angles from the second part piece 22, the third part piece 23 extending towards the rear wall 15 and being arranged in parallel with the first part piece 21. The third part piece 23 is constructed with inwardly bent punched openings 24 and with inwardly bent roundings 25, a circuit board 70 (see FIG. 6) being guided in each case between two roundings 25. The upper part 11 and the lower part 12 are in each case finished flush with the front part 13, characterized in that in each case a lug 26 with an opening 27 protrudes at the center, at which a covering hood can be attached. The upper part 11 and the lower part 12 are longer than the side parts 14, the upper part 11 having centrally a pot-shaped cutout at the end of which a lug 28 with thread is arranged which is bent perpendicularly downward (see FIG. 2). The lower part also has two openings 29, one opening 29 being covered in FIG. 2. On the parts 44, 45, protruding over the side parts 14, of the upper part 11 and the lower part 12, respectively, rotating bearings 30 for the levers 19 are arranged, characterized in that the protruding parts 44, 45 are used at the same time as support area for the levers 19. At the first part piece 21 of the side parts 14, wire guides 31 with in each case three outwardly bent fingers 32 are arranged at the end of which in each case a bend 33 is arranged. The rear wall 15 comprises a plate 34 in which ten slots 35 are inserted. At the rear wall 15, a lug 36 is attached which has three legs 37-39. The leg 37 is arranged centrally over the entire height at the rear wall 15. At the lower side of the leg 37, the leg 38 protrudes at a right angle, from which the leg 39 then protrudes obliquely downward. The lug 36 is permanently connected to the rear wall 15 via rivet connections 40, the rear wall 15 being screwed to the lug 28 via a screw 41. Furthermore, the leg 38 is screwed to the lower part 12 through the openings 29, only the nuts 42 of the screw connection being visible in FIG. 2. The leg 37 divides the rear wall 15 so that in each case five slits 35 are arranged on the left-hand side of the leg 37 and in each case five slots 35 are arranged on the right-hand side of the leg 37. One slot 35 in each case on the left and on the right form one pair and are exactly opposite a slot 17 on the front. The leg 39 is used for attaching a cable, whereas the wires of the cable run to the circuit board connectors 50 are attached to the leg 37. For this purpose, the leg 39 has a hole 43. The cable jacket is cut in and provided with holes, plastic tape being wound around the exposed cable core and the remaining cable jacket. Through the hole 43 and the holes in the cable jacket, a mushroom head screw is then inserted, tape is wound again around the cable end and the screw is tightened by a nut. In cables with shielding, this is grounded via the screw, preferably also using a metal contacting plate with teeth between screw and shielding for this purpose.

To equip the housing 10, five circuits boards 70 are inserted into the housing 10 from the rear, the circuit boards 70 in each case being guided between two roundings 25 on the left-hand and right-hand side part 14. Following this, the rear wall 15 is screwed on, the punched cutouts 24 forming stops for the rear wall 15 so that it is prevented that the rear wall 15 is pushed inward when the circuit boards are equipped with the circuit board connectors 50, and in each case ten circuit board connectors 50 are inserted on the circuit boards from the front and the rear of the housing 10. In this arrangement, the circuit board connectors 50 of the front are scarcely spaced apart whereas the circuit board connectors 50 of a row of the rear are separated by the leg 37 which why the housing 10 is also wider at the rear than at the front. So that the circuit board connectors 50 can pass the circuit boards 70 with their housing edges, they have cut-ins 74, 77, 78 (see FIG. 6) for the inwardly pointing side walls 51 of the circuit board connectors 50. The circuit board connectors 50 of the rear are equipped with arrester magazines 52 which, for example, are plugged into break contacts of the circuit board connectors 50, ground contacts constructed as double-forked contacts 53 of the arrester magazines 52 being pushed onto the front faces of the part pieces 23. Furthermore, it is shown in FIGS. 3 and 4 how the levers 19 are pivoted into an attachment position at carriers 60. The carriers 60 are constructed to be U-shaped in cross section. The lever has an opening 61 for the rotating bearing 30. Furthermore, the lever 19 has an excentric bend 62 at which a hook-shaped element 63 is arranged, the inside edge 64 of the hook-shaped element 63 being rounded. The hooked-shaped elements 63 of the four levers 19 engage the attachment position behind a leg 65 of a carrier 60 in each case and hold the terminal head 1 fixed on the carriers 60. In FIGS. 3 and 4, the two top circuit board connectors 50 of the front are covered with a label frame 54.

Each circuit board connector 50 can terminate ten pairs so that 100 pairs can be connected at the front and 100 pairs can be connected at the rear, that is to say a total of 200 pairs. However, the constructional height of the terminal head 1 is only half as high as that of a conventional terminal head. Since the terminal head 1 only covers less than one half of the width of the carrier, a further terminal head 1 can be easily arranged on the left and on the right so that, as a result, the terminal density is doubled. The correlation between the contacts of the circuit board connectors from the front to the rear is such that in each case one circuit board connector 50 of the front is connected to the circuit board connector 50 of the rear which is almost exactly opposite to it (almost because of the offset due to the leg 37), the almost opposite contacts in each case being connected to one another.

FIG. 6 shows a diagrammatic top view of a circuit board 70. In the area of the front end face 71, twenty contact pads 72 are arranged on the left and twenty contact pads 73 are arranged on the right for the two front circuit board connectors 50 which are inserted into the slot 17. In this arrangement, the circuit board 70 has a first cut-in 74 so that the right-hand side wall 51 of the left-hand circuit board connector and the left-hand side wall 51 of the right-hand circuit board connector 50 can slide past on the circuit board 70, the terminal contacts, preferably constructed as forked contacts, for the circuit board 70 preferably contacting the contact pads 72, 73. Since the two circuit board connectors 50 are arranged directly adjacently to one another at the front, one cut-in 74 is sufficient. At the rear, contact pads 75, 76 are correspondingly arranged for the circuit board connectors 50 of the rear 15. In this arrangement, the circuit board has two cut-ins 77, 78 since the two circuit board connectors 50 are arranged farther apart from one another. Laterally, the circuit board 50 is adapted to the shape of the side parts 14, the edges 79, 80 being offset towards the inside at the front and the rear so that the other side walls 51 of the circuit board connectors 50 can slide past the circuit board 70. The contact pads 72, 73, 75, 76 are preferably arranged at the top 81 and the bottom of the circuit board 70. The conductor runs between in each case one contact pad 72, 73 of the front and one contact pad 75, 76 at the rear are not shown. The conductor runs can be constructed uncrossed or crossed. To compensate for cross talk, the capacitive coupling between the layers of a multi-layer board as circuit board can also be utilized in supplementary fashion or as an alternative to crossing the conductor runs.

### List of Reference Designations

1 Terminal head

10 Housing

11 Top part

12 Bottom part

13 Front part

14 Side part

15 Rear wall

16 Metal rails

17 Slots

18 Lugs

19 Levers

20 Openings

21 First part piece

22 Second part piece

23 Third part piece

24 Bent cutout

25 Roundings

26 Lug

27 Opening

28 Lug

29 Openings

30 Rotating bearing

31 Wire guides

32 Finger

33 Bend

34 Plate

35 Slots

36 Lug

37-39 Leg

40 Riveted connections

41 Screw

42 Nuts

43 Hole

44 Protruding part (top part)

45 Protruding part (bottom part)

50 Circuit board connector

51 Side walls

52 Arrester magazine

53 Forked contact

54 Label frame

60 Carrier

61 Opening

62 Bend

63 Hook-shaped element

64 Inside edge

65 Leg

70 Circuit board

71 Front face

72 Contact pad

73 Contact pad

74 Cut-in

75 Contact pad

76 Contact pad

77 Cut-in

78 Cut-in

79 Edge

80 Edge

81 Top

1. A terminal head for telecommunication and data engineering, comprising a housing in which terminal strips are arranged for interconnecting a predetermined number of pairs, the housing being constructed with attachment means by means of which the housing can be attached to carriers, wherein the terminal strips are constructed as circuit board connectors, a number of circuit boards being arranged in the housing, which circuit boards are accessible from the front and the rear of the housing, the circuit board connectors being plugged onto the circuit boards from the front of the housing and plugged onto the circuit boards from the rear of the housing, in each case conductor runs being arranged on the circuit boards, via which circuit boards in each case one contact of a circuit board connector of the front is connected to a contact of a circuit board connector of the rear via the in each case common circuit board.

2. The terminal head as claimed in claim 1, wherein the housing has a detachable rear wall.

3. The terminal head as claimed in claim 1, wherein a lug for attaching a cable is arranged at the rear wall.

4. The terminal head as claimed in claim 3, wherein the lug has a leg which is arranged centrally over the entire height at the rear wall.

5. The terminal head as claimed in claim 1, wherein the housing is constructed to be stepped, the housing being wider at the rear than at the front.

6. The terminal head as claimed in claim 1, wherein the housing is of metal or metalized.

7. The terminal head as claimed in claim 1, wherein onto each circuit board, two circuit board connectors are plugged from the front and two circuit board connectors are plugged from the rear, the distance between the circuit board connectors of the rear being greater.

8. The terminal head as claimed in claim 1, wherein guides for jumper wires are arranged in each case at the front part pieces of the side parts.

9. The terminal head as claimed in claim 1, wherein the circuit board connectors of the rear and/or the front are constructed with interfaces for an arrester magazine.

10. The terminal head as claimed in claim 1 wherein on the top part and/or the bottom part of the housing, pivotable levers are arranged by means of which the terminal head can be attached to carriers.

11. The terminal head as claimed in claim 10, wherein two pivotable levers are arranged in each case on the top part and the bottom part of the housing.

12. The terminal head as claimed in claim 10, wherein the levers have an excentric bend at which a hook-shaped element is arranged.

13. The terminal head as claimed in claim 10, wherein the housing is constructed with stopping means for the levers.
